(19) United States
(12) Patent Application Publication
(10) Pub. No.: US 2017/0102017 A1
(43) Pub. Date: Apr. 13, 2017

(54) MULTISECURING COMPONENT

(71) Applicant: FIVETECH TECHNOLOGY INC., NEW TAIPEI CITY (TW)

(72) Inventor: TING-JUI WANG, NEW TAIPEI CITY (TW)

(21) Appl. No.: 15/286,783

(22) Filed: Oct. 6, 2016

(30) Foreign Application Priority Data
Oct. 8, 2015 (TW) 104216190

(51) Int. Cl. F16B 5/04; F16B 5/02; F16B 5/08

(52) U.S. Cl. CPC F16B 5/04; F16B 5/08; F16B 5/02

(57) ABSTRACT

A multisecuring component includes a penetrating securing body penetratingly secured to a third object and having an abutting protruding portion for abutting against the third object; and a first securing portion disposed on a side of the penetrating securing body to secure a first object, or a second securing portion disposed on another side of the penetrating securing body to secure a second object. Therefore, the multisecuring component secures multiple objects easily.

### CROSS-REFERENCE TO RELATED APPLICATION

This non-provisional application claims priority under 35 U.S.C. §119(a) on Patent Application No(s).104216190 filed in Taiwan, R.O.C. on Oct. 8, 2015, the entire contents of which are hereby incorporated by reference.

### FIELD OF THE INVENTION

The present invention relates to multisecuring components and, more particularly, to a multisecuring component which secures multiple objects easily.

### BACKGROUND OF THE INVENTION

Conventional securing components are each typically used to secure two objects. However, securing three objects requires using a securing component to secure one of the two objects and a third object together, thereby compromising the ease of use of the conventional securing components. Accordingly, it is important to invent a multisecuring component for securing multiple objects easily.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a multisecuring component as disclosed in the present invention to secure multiple objects easily.

In order to achieve the above and other objectives, the present invention provides a multisecuring component, comprising: a penetrating securing body penetratingly secured to a third object and having an abutting protruding portion for abutting against the third object; and a first securing portion disposed on a side of the penetrating securing body to secure a first object, or a second securing portion disposed on another side of the penetrating securing body to secure a second object.

Regarding the multisecuring component, the abutting protruding portion is disposed on one side or between two sides of the penetrating securing body.

Regarding the multisecuring component, the penetrating securing body further has a penetrating securing surface which has at least one securing plane, at least one securing slope, at least one securing curved surface, at least one securing arcuate surface, at least one securing convex surface, at least one securing concave surface or a combination thereof, with the penetrating securing surface penetratingly secured to the third object.

Regarding the multisecuring component, the penetrating securing body has a connecting portion adjacent to the abutting protruding portion and connected and secured to the third object.

Regarding the multisecuring component, the first securing portion is a screw hole, a stud, a buckle, a cylinder, an inner fastener, a bonding element or a magnetic attraction element for securing the first object, or the second securing portion is a screw hole, a stud, a buckle, a cylinder, an inner fastener, a bonding element or a magnetic attraction element for securing the second object.

Regarding the multisecuring component, when the first securing portion is the screw hole, the multisecuring component further comprises a first screw which works together with the screw hole in securing the first object, or, when the second securing portion is the screw hole, the multisecuring component further comprises a second screw which works together with the screw hole in securing the second object.

Regarding the multisecuring component, when the first securing portion is the stud, the multisecuring component further comprises a first nut which works together with the stud in securing the first object, or, when the second securing portion is the stud, the multisecuring component further comprises a second nut which works together with the stud in securing the second object.

Regarding the multisecuring component, the abutting protruding portion is symmetric or asymmetric.

Regarding the multisecuring component, the abutting protruding portion is connected and secured to the third object, the first object or the second object by welding, riveting, expanding, fastening, locking or bonding.

Regarding the multisecuring component, the penetrating securing surface is connected and secured to the third object, the first object or the second object by welding, riveting, expanding, fastening, locking or bonding.

Regarding the multisecuring component, the connecting portion is connected and secured to the third object, the first object or the second object by welding, riveting, expanding, fastening, locking or bonding.

Regarding the multisecuring component, the third object is a printed circuit board which displays weldability.

Regarding the multisecuring component, the third object has a solder layer for being welded to the penetrating securing body.

The present invention further provides a securing module which comprises the third object and the multisecuring component.

The present invention further provides a securing module which comprises the third object, the multisecuring component and the first object, or comprises the third object, the multisecuring component and the second object.

The present invention further provides a securing combination, comprising a plurality of aforesaid multisecuring components and a vehicle, with the multisecuring components disposed in the vehicle.

The securing combination further comprises a lid disposed at the vehicle to cover the multisecuring components.

Regarding the securing combination, the vehicle is cord-shaped or disk-shaped.

Accordingly, the multisecuring component of the present invention secures multiple objects easily.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of a multisecuring component according to a preferred embodiment of the present invention;

FIG. 2 is a cross-sectional view of the multisecuring component according to the preferred embodiment of the present invention;

FIG. 3 provides top views of the top of the multisecuring component according to the preferred embodiment of the present invention;

FIG. 4 is a schematic view of an asymmetric abutting protruding portion of the multisecuring component according to the preferred embodiment of the present invention;

FIG. 5 provides schematic views of a first securing portion and a second securing portion of the multisecuring component according to the preferred embodiment of the present invention;

FIG. 6 is the first schematic view of how the multisecuring component in the preferred embodiment of the present invention operates;

FIG. 7 is the second schematic view of how the multisecuring component in the preferred embodiment of the present invention operates;

FIG. 8 is the third schematic view of how the multisecuring component in the preferred embodiment of the present invention operates;

FIG. 9(a) is a top view of FIG. 8 with a first screw removed;

FIG. 9(b) is a bottom view of FIG. 8 with the first screw removed;

FIG. 10 is a schematic view of a securing combination according to the preferred embodiment of the present invention.

### DETAILED DESCRIPTION OF THE PREFERRED EMBODIMENTS

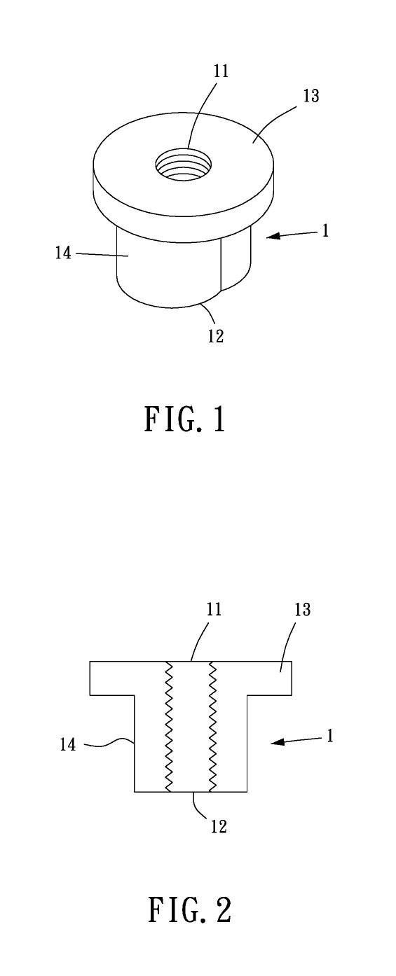

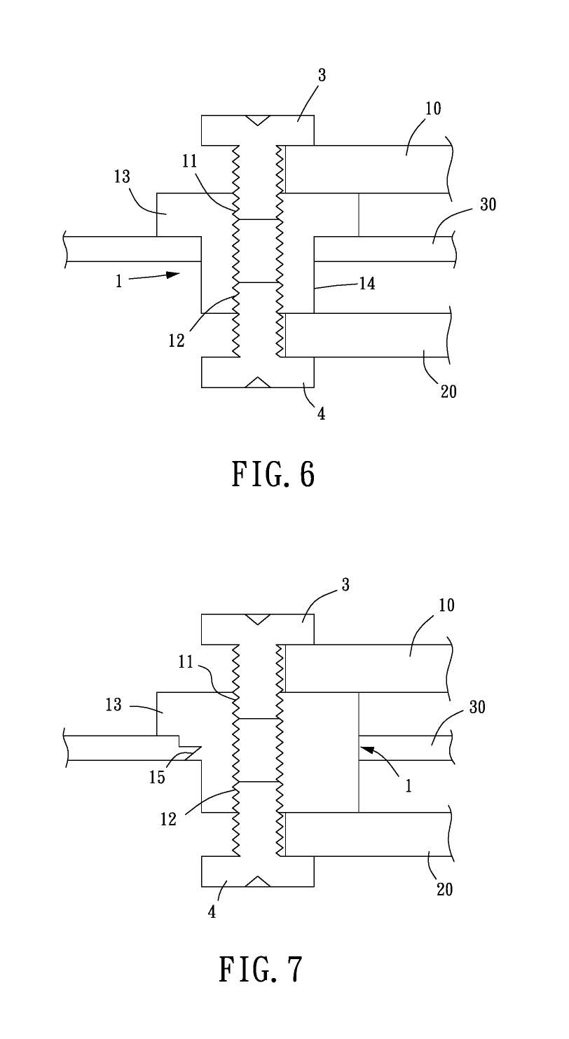

Referring to FIG. 1, FIG. 2 and FIG. 6, the present invention provides a multisecuring component which comprises a penetrating securing body 1 and a first securing portion 11 and/or a second securing portion 12. The penetrating securing body 1 is cylindrical and penetratingly secured to a through hole of a third object 30. The shape of the cross section of the through hole is the same as the shape of the cross section of the penetrating securing body 1. An abutting protruding portion 13 for abutting against the third object 30 is disposed on one side of the penetrating securing body 1. The third object 30 is a plate. The first securing portion 11 is disposed on one side of the penetrating securing body 1 to secure a first object 10. The first object 10 is a plate and rests longitudinally on the abutting protruding portion 13. The first securing portion 11 is a screw hole which works together with an external component in securing the first object 10. The second securing portion 12 is disposed on the other side of the penetrating securing body 1 to secure a second object 20. The second securing portion 12 faces away from the first securing portion 11. The second object 20 is a plate. The second object 20 rests longitudinally on the abutting protruding portion 13, when the abutting protruding portion 13 is disposed on the other side of the penetrating securing body 1. Alternatively, the second securing portion 12 is a screw hole which works together with another external component in securing the second object 20. The second securing portion 12 is in communication with the first securing portion 11. Both the abutting protruding portion 13 and the first securing portion 11 are disposed on the same side of the penetrating securing body 1; alternatively, both the abutting protruding portion 13 and the second securing portion 12 are disposed on the same side of the penetrating securing body 1. It is easy for the multisecuring component of the present invention to secure the first object 10 and the third object 30 together, the second object 20 and the third object 30 together, or the first object 10, the second object 20 and the third object 30 together. The first object 10, the second object 20 and the third object 30 are a printed circuit board, a plastic plate, and a metal plate, respectively. Furthermore, the distance between the first object 10 and the third object 30 equals the distance between the second object 20 and the third object 30.

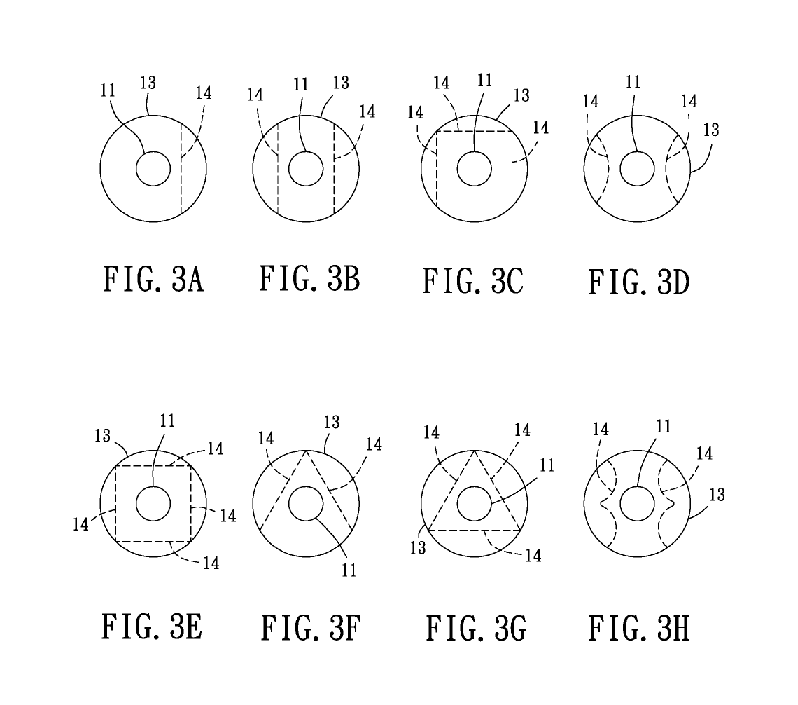

Referring to FIG. 1, FIG. 3 and FIG. 6, regarding the multisecuring component, the penetrating securing body 1 further has a penetrating securing surface 14 which has at least one securing plane (shown in FIG. 3 (a)(b)(c)(e)), at least one securing slope (shown in FIG. 3 (f)(g)), at least one securing curved surface (shown in FIG. 3 (h)), at least one securing arcuate surface (shown in FIG. 3 (d)), at least one securing convex surface (shown in FIG. 3 (h)), at least one securing concave surface (shown in FIG. 3 (d)), or a combination thereof. The penetrating securing surface 14 is penetratingly secured to the through hole of the third object 30 by friction.

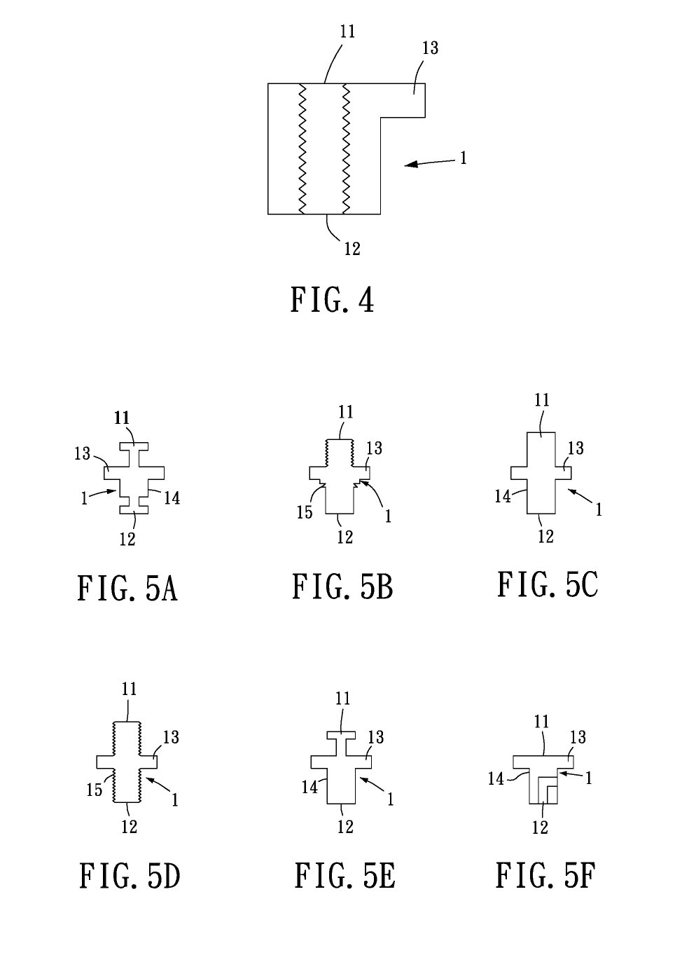

Referring to FIG. 4 and FIG. 7, regarding the multisecuring component, the abutting protruding portion 13 is symmetric as shown in FIG. 1 through FIG. 3 or asymmetric. The multisecuring component operates in the same manner, regardless of whether the abutting protruding portion 13 is symmetric or asymmetric.

Referring to FIG. 5 (b) and FIG. 7, regarding the multisecuring component, the penetrating securing body 1 has a connecting portion 15 adjacent to the abutting protruding portion 13. The connecting portion 15 is connected and secured to the third object 30. In addition to being connected and secured to the third object 30 by expanding, the connecting portion 15 can be connected and secured to the third object 30 (or to the first object 10 or the second object 20) by welding, riveting, fastening, locking or bonding. Likewise, the abutting protruding portion 13 or the penetrating securing surface 14 is connected and secured to the third object 30 (or to the first object 10 or the second object 20) by welding, riveting, expanding, fastening, locking or bonding.

Referring to FIG. 5, regarding the multisecuring component, in addition to being the screw hole as shown in FIG. 2, the first securing portion 11 can be a stud (shown in FIG. 5 (b)(d)), a buckle (shown in FIG. 5 (a)(e)), a cylinder (shown in FIG. 5 (c)), an inner fastener (of the same structure as the second securing portion 12 shown in FIG. 5 (f)), a bonding element (shown in FIG. 5 (f)) or a magnetic attraction element (shown in FIG. 5 (f)) for securing the first object 10. Alternatively, in addition to being the screw hole shown in FIG. 2, the second securing portion 12 can be a stud (shown in FIG. 5 (d)), a buckle (shown in FIG. 5 (a)), a cylinder (shown in FIG. 5 (b)(c)(e)), an inner fastener (shown in FIG. 5 (f)), a bonding element (of the same structure as the first securing portion 11 shown in FIG. 5 (f)) or a magnetic attraction element (of the same structure as the first securing portion 11 shown in FIG. 5 (f)) for securing the second object 20.

Referring to FIG. 6, regarding the multisecuring component, when the first securing portion 11 is the screw hole, the multisecuring component further comprises a first screw 3 which works together with the screw hole in securing the first object 10, or, when the second securing portion 12 is the screw hole, the multisecuring component further comprises a second screw 4 which works together with the screw hole in securing the second object 20. Referring to FIG. 5 (d), when the first securing portion 11 is the stud, the multisecuring component further comprises a first nut (not shown) which works together with the stud in securing the first object 10, or, when the second securing portion 12 is the stud, the multisecuring component further comprises a second nut (not shown) which works together with the stud in securing the second object 20.

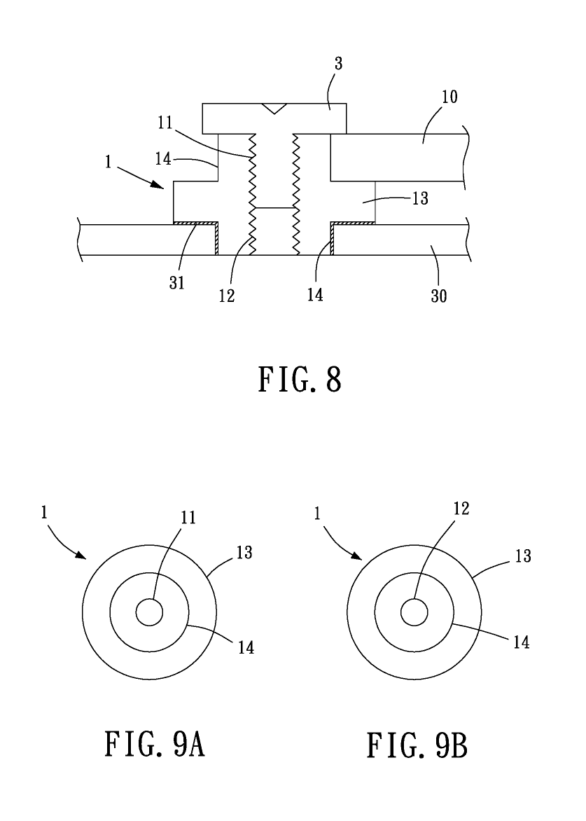

Referring to FIG. 8 and FIG. 9, FIG. 1 and FIG. 6, the abutting protruding portion 13 is disposed on one side of the penetrating securing body 1 or between two sides of the penetrating securing body 1. Therefore, the penetrating securing surface 14 blocks the first object 10 (or the second object 20) laterally. The third object 30 is a printed circuit board which displays weldability; for example, the third object 30 has a solder layer 31 for being welded to the penetrating securing body 1.

Referring to FIG. 6 and FIG. 7, the present invention further provides a securing module which comprises the third object 30 and the multisecuring component.

Referring to FIG. 6 and FIG. 7, the present invention further provides a securing module which comprises the third object 30, the multisecuring component and the first object 10, or comprises the third object 30, the multisecuring component and the second object 20.

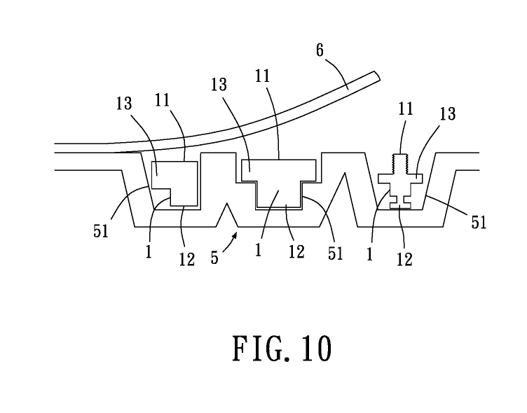

Referring to FIG. 10, the present invention further provides a securing combination which comprises a plurality of aforesaid multisecuring components and a vehicle 5. The multisecuring components are disposed in a plurality of receiving chambers 51 of the vehicle 5, respectively.

Referring to FIG. 10, the securing combination further comprises a lid 6 disposed at the vehicle 5 to cover the multisecuring components.

Referring to FIG. 10, regarding the securing combination, the vehicle 5 is cord-shaped as shown in the diagram or extends in the direction perpendicular to the drawing paper which displays FIG. 10 to become disk-shaped.

The present invention is disclosed above by preferred embodiments. However, persons skilled in the art should understand that the preferred embodiments are illustrative of the present invention only, but should not be interpreted as restrictive of the scope of the present invention. Hence, all equivalent variations and replacements made to the aforesaid embodiments should fall within the scope of the present invention. Accordingly, the legal protection for the present invention should be defined by the appended claims.

What is claimed is:

1. A multisecuring component, comprising:
a penetrating securing body penetratingly secured to a third object and having an abutting protruding portion for abutting against the third object; and
a first securing portion disposed on a side of the penetrating securing body to secure a first object, or a second securing portion disposed on another side of the penetrating securing body to secure a second object.

2. The multisecuring component of claim 1, wherein the abutting protruding portion is disposed on one side or between two sides of the penetrating securing body.

3. The multisecuring component of claim 1, wherein the penetrating securing body further has a penetrating securing surface which has at least one securing plane, at least one securing slope, at least one securing curved surface, at least one securing arcuate surface, at least one securing convex surface, at least one securing concave surface or a combination thereof, with the penetrating securing surface penetratingly secured to the third object.

4. The multisecuring component of claim 1, wherein the penetrating securing body has a connecting portion adjacent to the abutting protruding portion and connected and secured to the third object.

5. The multisecuring component of claim 1, wherein the first securing portion is a screw hole, a stud, a buckle, a cylinder, an inner fastener, a bonding element or a magnetic attraction element for securing the first object, or the second securing portion is a screw hole, a stud, a buckle, a cylinder, an inner fastener, a bonding element or a magnetic attraction element for securing the second object.

6. The multisecuring component of claim 5, wherein, when the first securing portion is the screw hole, the multisecuring component further comprises a first screw which works together with the screw hole in securing the first object, or, when the second securing portion is the screw hole, the multisecuring component further comprises a second screw which works together with the screw hole in securing the second object.

7. The multisecuring component of claim 5, wherein, when the first securing portion is the stud, the multisecuring component further comprises a first nut which works together with the stud in securing the first object, or, when the second securing portion is the stud, the multisecuring component further comprises a second nut which works together with the stud in securing the second object.

8. The multisecuring component of claim 1, wherein the abutting protruding portion is symmetric or asymmetric.

9. The multisecuring component of claim 1, wherein the abutting protruding portion is connected and secured to the third object, the first object or the second object by welding, riveting, expanding, fastening, locking or bonding.

10. The multisecuring component of claim 3, wherein the penetrating securing surface is connected and secured to the third object, the first object or the second object by welding, riveting, expanding, fastening, locking or bonding.

11. The multisecuring component of claim 4, wherein the connecting portion is connected and secured to the third object, the first object or the second object by welding, riveting, expanding, fastening, locking or bonding.

12. The multisecuring component of claim 1, wherein the third object is a printed circuit board which displays weldability.

13. The multisecuring component of claim 1, wherein the third object has a solder layer for being welded to the penetrating securing body.

14. A securing module, comprising the third object and the multisecuring component of claim 1.

15. A securing module, comprising the third object, the multisecuring component of claim 1, and the first object, or comprising the third object, the multisecuring component of claim 1, and the second object.

16. A securing combination, comprising a plurality of said multisecuring components of claim 1 and a vehicle, with the multisecuring components disposed in the vehicle.

17. The securing combination of claim 16, further comprising a lid disposed at the vehicle to cover the multisecuring components.

18. The securing combination of claim 16, wherein the vehicle is cord-shaped or disk-shaped.
